(19) United States
(12) Patent Application Publication
(10) Pub. No.: US 2013/0193172 A1
(43) Pub. Date: Aug. 1, 2013

(54) Mold and method of using the same in the manufacture of holsters

(71) Applicant: Michael J. Damkot, Purcellville, VA (US)

(72) Inventors: Michael J. Damkot, Purcellville, VA (US); Jason H. Bourland, Leesburg, VA (US)

(21) Appl. No.: 13/385,015

(22) Filed: Jan. 27, 2012

(51) Int. Cl. F41C 33/02; B29C 51/00; B29C 51/30

(52) U.S. Cl. 224/191; 425/394; 264/297.4

(57) ABSTRACT

A forming mold and method using the forming mold to form thermoplastic sheets into a more comfortable and concealable weapon holster. The two piece forming mold includes an upper section and a lower section having mating concave and convex surfaces. The upper section includes a deformable foam pad mounted to its concave inner surface and the lower section includes a deformable foam pad mounted atop its convex upper surface. The curvature of the mating concave and convex surfaces approximates the curvature of the average human hip. The foam pad mounted to the concave inner surface of the upper mold section is thicker than the foam pad mounted to the convex outer surface of the lower mold section.

This invention relates to the construction of holsters, sheaths and similar carriers from thermoplastic sheets, and in particular a forming mold and method of using the same for forming thermoplastic sheets into holster, sheaths and the like.

### BACKGROUND OF THE INVENTION

Heat formable thermoplastic sheets, such as KYDEX, are often used for weapon holsters, magazine carriers, knife sheaths, and similar carriers. KYDEX is very rigid and is resistant to chemicals, fire, water and impact, but more importantly can be bent and molded after it is heated. Kydex sheets are used to form the holsters and mounts, and are fairly easily molded to accommodate desired features of the target handgun, such as molded areas corresponding to the trigger guard or barrel. Similar stiff, plastic or plastic-like materials can be used and the formation of the shell parts could be injection molded, vacuum formed, thermo-formed, or even pressure molded.

The method for making thermoplastic holsters and sheaths consists generally of heating your thermoplastic sheets to 240-375° F. (depending on the heat time) in an oven or using a heat gun, molding the sheet around the shape and contour of the weapon, and then allowing the sheets to cool in the desired shape around the weapon. A simple hinged press is often used to mold the sheets around the weapon. The press generally includes two foam mats that are sandwiched between flat press plates. The press plates compress the thermoplastic sheets around the weapon between the foam mats, which helps mold the heated thermoplastic sheets to the shape and contour of the weapon. The mats are generally formed of an ethylene vinyl acetate (EVA) or neoprene foam.

Heretofore, molding the holster and sheaths around the weapon between two foam pads has produced holsters that form symmetrically to the shape and contour of the weapon, but do not necessarily conform nicely to the contour of the user's body. Because holsters and sheaths formed between two foam mats sandwiched between flat press plates, the thermoplastic sheets that form the front and back of the holster or sheath are symmetrically molded and formed around the weapon. Consequently, the formed holster body nicely fits the shape of the weapon, but does not comfortably conform to the curvature of the wearer's body.

### SUMMARY OF THE INVENTION

The present invention seeks to provide a forming mold and method using the forming mold to form thermoplastic sheets into a more comfortable and concealable weapon holster. The two piece forming mold includes an upper section and a lower section having mating concave and convex surfaces. The upper section includes a deformable foam pad mounted to its concave inner surface and the lower section includes a deformable foam pad mounted atop its convex upper surface. The curvature of the mating concave and convex surfaces approximates the curvature of the average human hip. The foam pad mounted to the concave inner surface of the upper mold section is thicker than the foam pad mounted to the convex outer surface of the lower mold section. When a holster is formed using the forming mold, the front and back sheets are formed asymmetrically around the weapon. The difference in the thickness of the two foam pads and the curvature of the mating concave and convex surfaces allows the thermoplastic sheet that forms the front of the holster to wrap and form around the weapon more than the sheet that forms the back of the holster. Consequently, the back of the holster has a smoother curved contour that approximates the curvature of the human hip, which provides a more secure, concealable and comfortable fit for the user, while the front of the holster forms further around the weapon to provide secure weapon retention.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangements of system and method components. The drawings are only for purposes of illustrating exemplary embodiments and are not to be construed as limiting the invention. The drawings illustrate the present invention, in which:

FIG. 1 is a bottom perspective view of an embodiment of the concave shaping mold of this invention;

FIG. 2 is a top perspective view of an embodiment of the convex shaping mold of this invention;

FIG. 3 is a perspective view of an embodiment of a press using the concave shaping mold of FIG. 1 and the convex shaping mold of FIG. 2;

FIG. 4 is a side sectional view of the press of FIG. 3 shown in the open position;

FIG. 5 is a side sectional view of the press of FIG. 3 shown in the closed position;

FIG. 6 is a sectional view of the press taken along ling 6-6 of FIG. 5;

FIG. 7 is a simplified perspective of a thermoplastic sheet being heated showing a step of forming a holster using the method of this invention;

FIG. 8 is a simplified perspective of the thermoplastic sheets being heated showing an alternative step of forming a holster using the method of this invention;

FIG. 9 is a partial perspective view of the forming mold of FIGS. 1 and 2 showing a weapon being placed between two heated sheets of kydex within the forming mold;

FIG. 10 is another partial perspective view of the forming mold of FIGS. 1 and 2 showing a weapon being placed between two heated sheets of kydex within the forming mold;

FIG. 11 is a simplified end view of the weapon being placed between two heated sheets of thermoplastic material and the concave shaping mold of FIG. 1 and the convex shaping mold of FIG. 2 showing another step of forming a holster using the method of this invention;

FIG. 12 is another simplified end view of a weapon being pressed between two heated thermoplastic sheets and the concave shaping mold of FIG. 1 and the convex shaping mold of FIG. 2 showing another step of forming a holster using the method of this invention;

FIG. 13 is a simplified perspective of the thermoplastic sheets formed around the weapon and being cut in the final shape of a holster;

FIG. 14 is a simplified perspective view of the weapon and the newly shaped holster after being removed from the concave shaping mold of FIG. 1 and the convex shaping mold of FIG. 2 showing another step of forming a holster using the method of this invention;

FIG. 15 is a simplified perspective view of the holster with belt slots and rivets being fitted to the holster showing another step of forming a holster using the method of this invention;

FIG. 16 is a perspective view of a finished holster constructed using the method of this invention;

FIG. 17 is a side view of the holster of FIG. 13;

FIG. 18 is a top view of the holster of FIG. 13; and

FIG. 19 is a front view of the holster of FIG. 13 shown fitted to a belt.

### DESCRIPTION OF THE PREFERRED EMBODIMENT

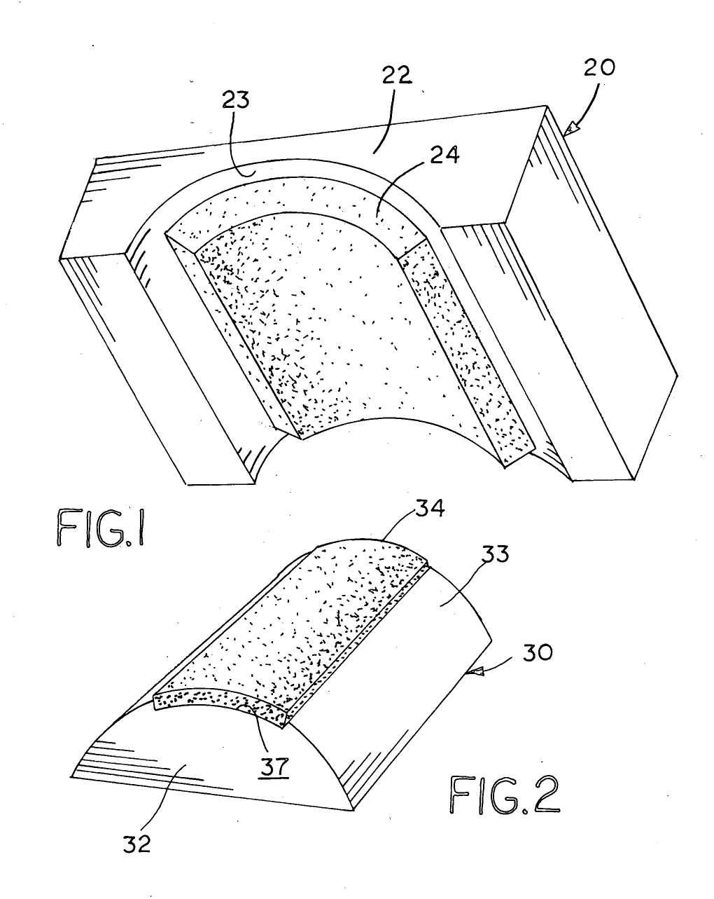

Referring now to the drawings, FIGS. 1 and 2 illustrate an embodiment of the two piece forming mold of this invention, which together are designated generally as reference numeral 10. Forming mold 10 includes an upper section 20 (FIG. 1) mold 10 and a lower section 30 (FIG. 2). Upper section 20 includes a rigid arciform mold body 22 and a deformable foam pad 24 mounted to a concave inner surface 23 formed in body 22. Lower section 20 includes a rigid cylindrically curved mold body 32 and a deformable foam pad 34 seated within a shallow longitudinal recess 37 formed in convex upper surface 33 of the mold body 32. It should be noted that concave inner surface 23 and arched upper surface 33 share approximately the same curvature, so that upper section 20 nests over lower section 20. The curvature of concave surface 23 and convex surface 33 is approximately 30 degrees, which approximates the curvature of the side of the average human hip.

Mold bodies 22 and 32 may be formed, molded or constructed from any suitable material, such as wood, polymer plastics, metal or composite materials as desired. Typically, the material composition of the mold bodies is selected to facilitate the conduction or transfer thermal energy away from the heated thermoplastic sheets, thereby speeding the cooling process and setting of the formed sheets. Foam pads 24 and 34 are generally formed of an ethylene vinyl acetate (EVA) or neoprene foam. The deformable properties of foam pads 24 and 34 allow the heated thermoplastic sheets to be formed around a weapon when pressed into the pads. As shown, foam pad 24 is thicker than foam pad 34 by a ratio ranging between 3/1 or 4/1 with the thickness of pad 24 generally between 0.75-1.50 inches and the thickness of foam pad 34 generally between 0.25 and 0.5 inches.

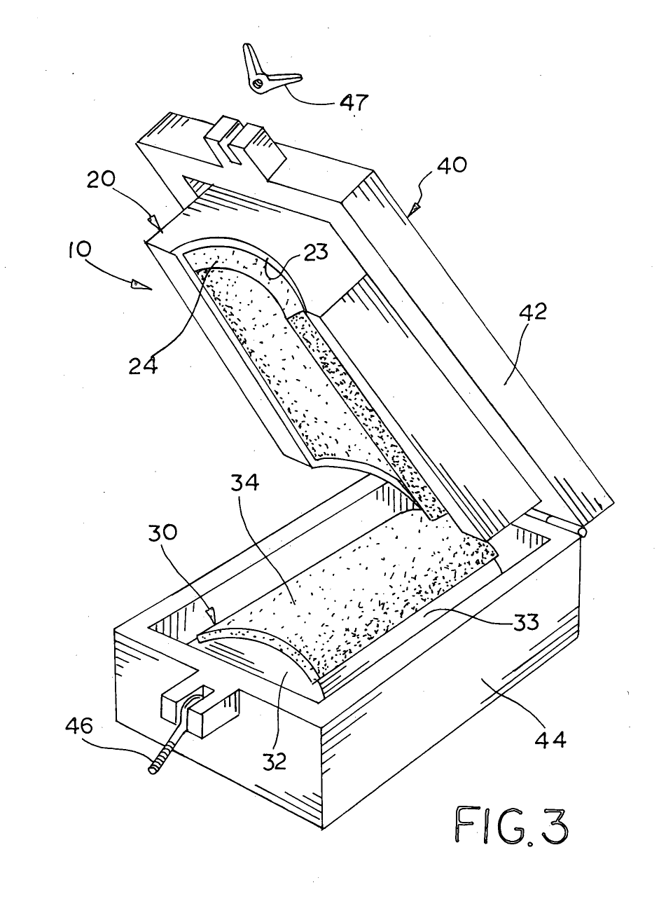

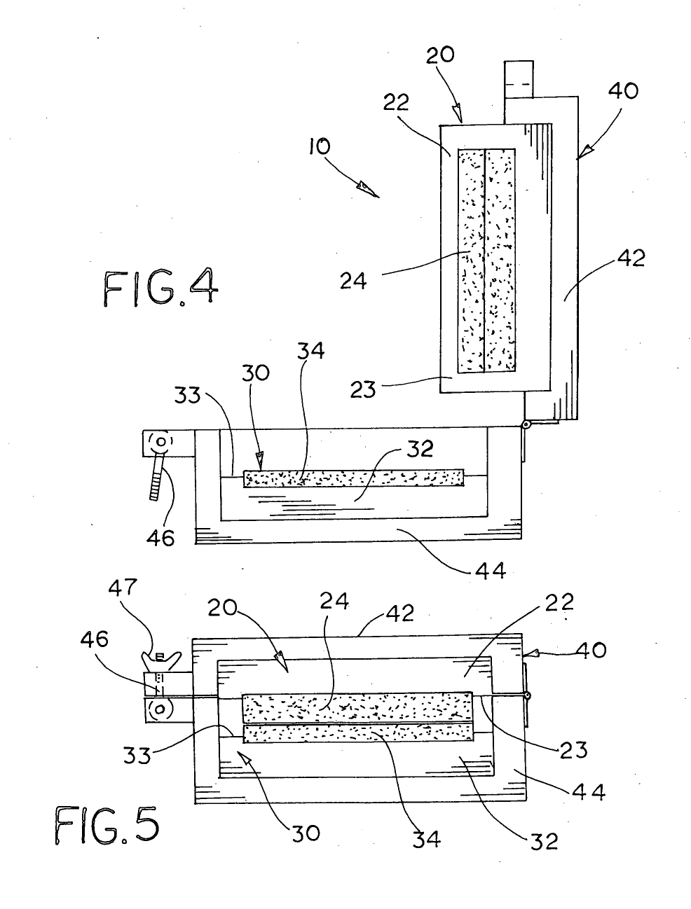

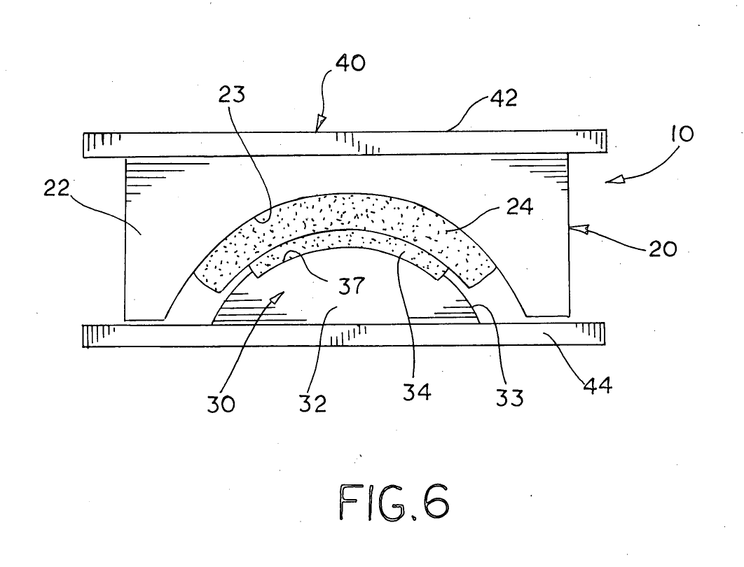

FIGS. 3-6 show forming mold 10 used in a forming press 40. Forming press 40 uses a conventional design, but is adapted to accommodate the height of forming mold 10. Press 40 includes a pivoting top plate 42 hinged to a base 44. As shown, upper section 20 is mounted to the bottom of top plate 42 and lower section 30 is mounted within base 44 so that the upper section is pivoted away from the lower section when the press is open (FIG. 4) and compressively seats over the top lower section when the press is closed (FIGS. 5 and 6). Press 40 is held shut by a threaded bolt 46 and wing nut 47.

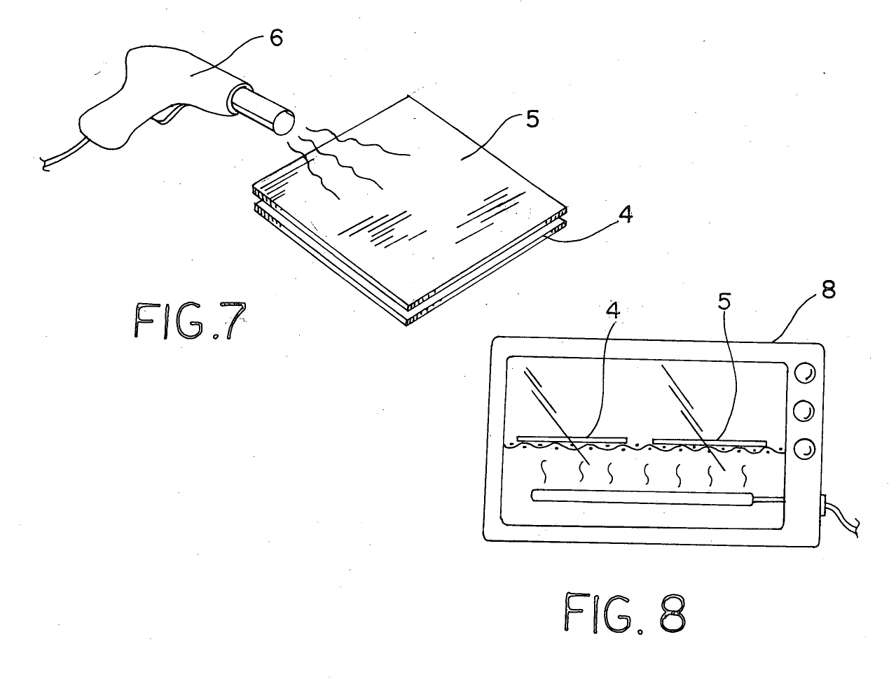

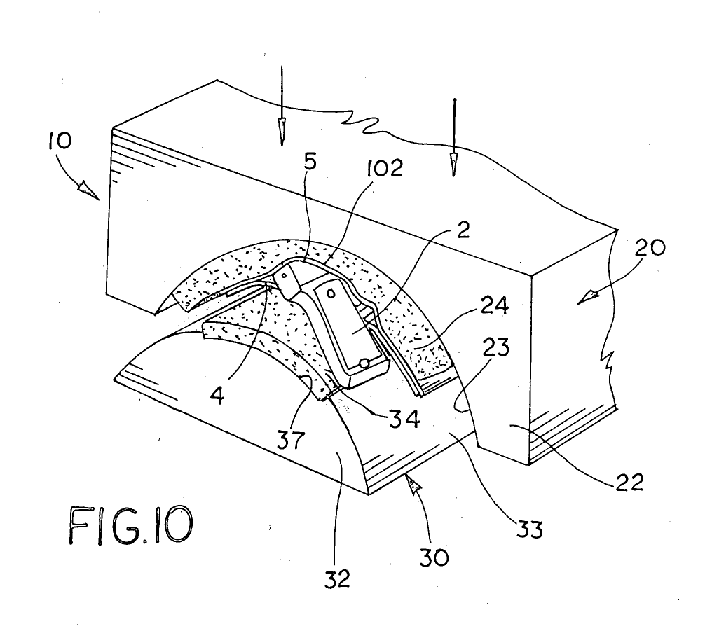

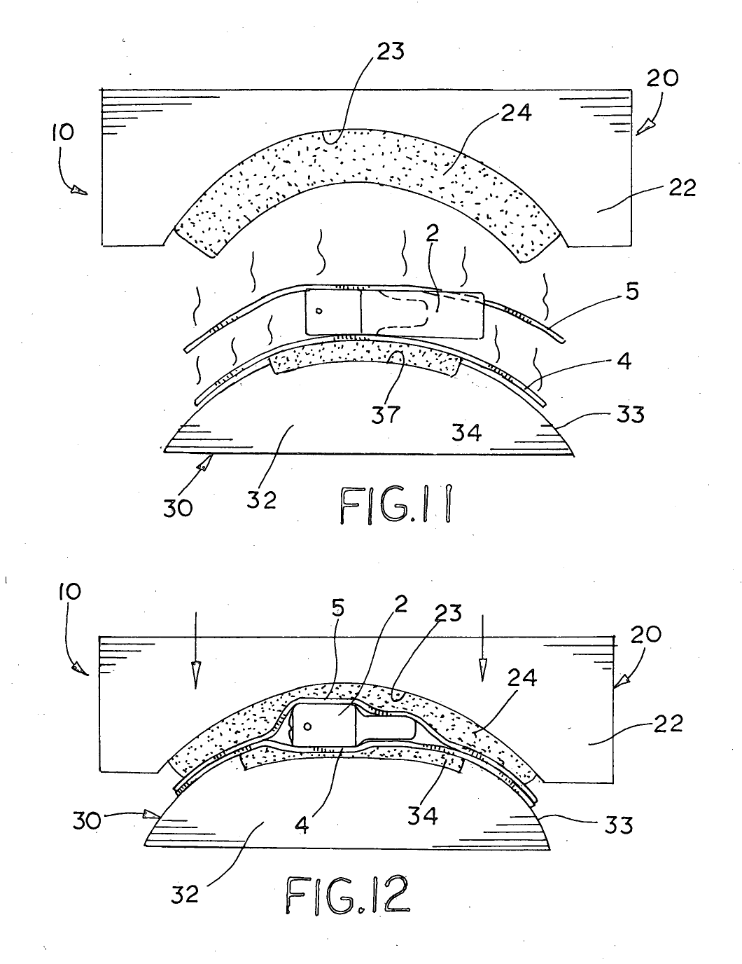

FIGS. 7-15 illustrate the method of this invention for forming thermoplastic sheets into a weapon holster and other similar holsters, sheaths and carriers using forming mold 10. This method may be used with any heat formable thermoplastic sheets, such as Kydex®. Kydex® is an extremely durable thermoplastic acrylic/PVC alloy and is the preferred material for weapon holsters due to its properties of longevity and durability. Kydex® is available from Kleerdex Company of Mount Laurel, New Jersey in various grades and thicknesses. While the method of this invention is illustrated in the forming and construction of a holster for a pistol, the method can be used to form and construct holsters, sheaths and carriers or other articles, such as knives, flashlights, ammunition magazines and radios.

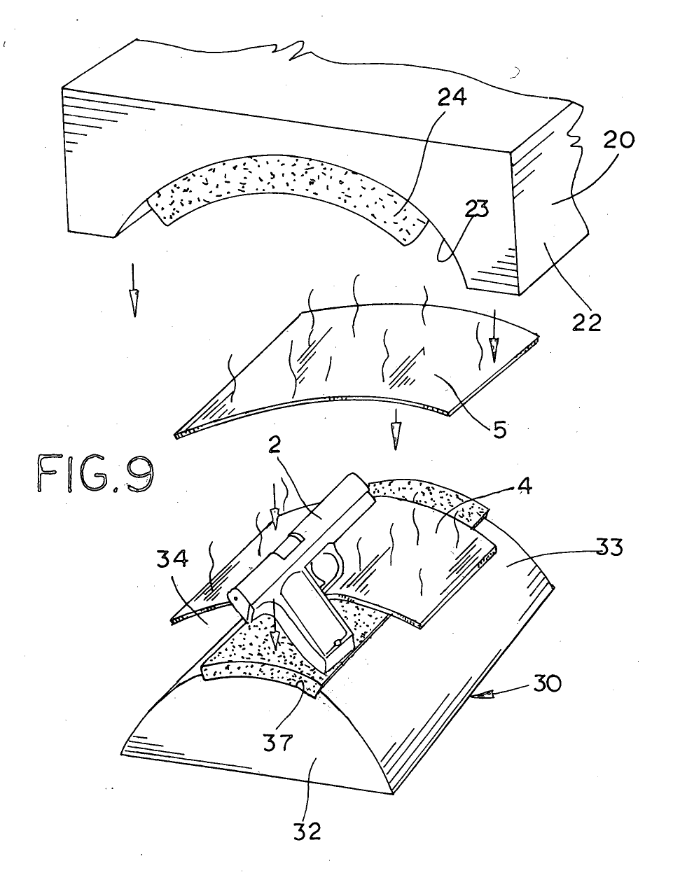

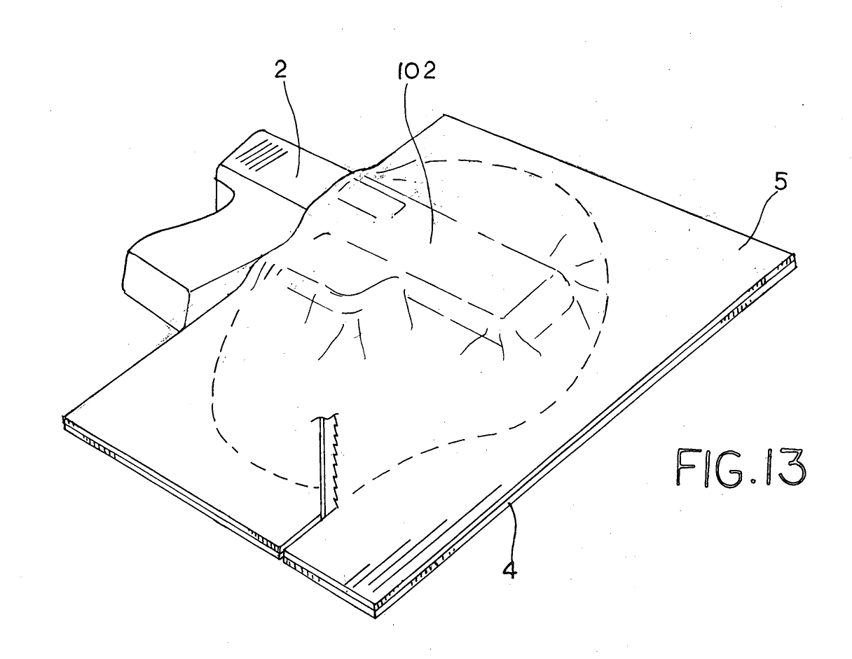

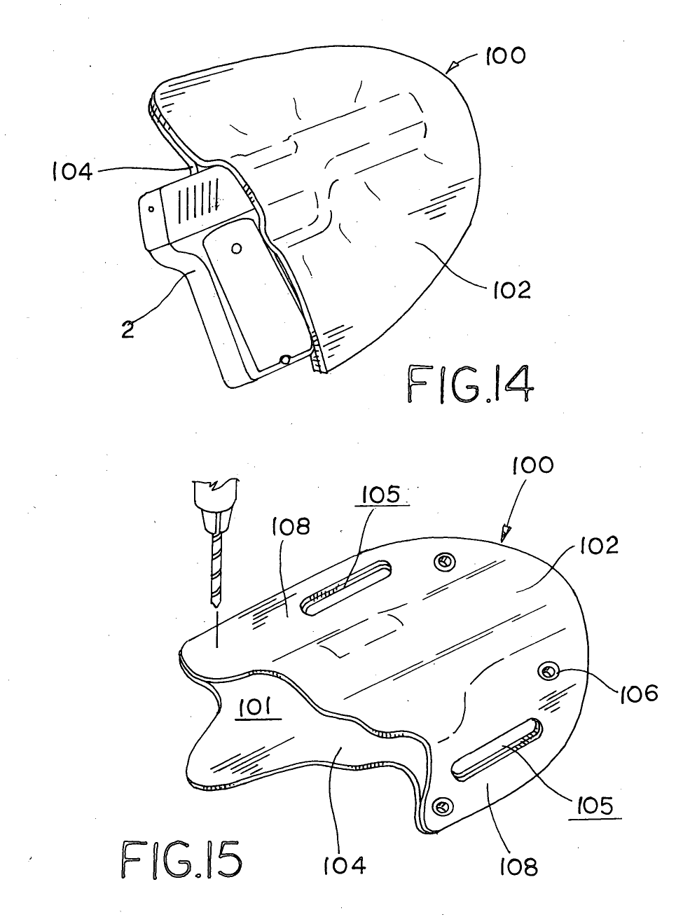

The method begins by heating two sheets of thermoplastic material (designated as reference numerals 4 and 5), which will form the front and back 102 and 104 of the holster, as shown in FIGS. 7 and 8. Thermoplastic sheets 4 and 5 are heated in order bring the thermoplastic materials into a readily pliable state, typically between 240-375° F. depending on the grade and thickness of the thermoplastic material. Typically, sheets 4 and 5 are manually heated using a handheld heat gun 6 (FIG. 7) or are heated inside an oven 8 (FIG. 8). Once both sheets 4 and 5 are sufficiently pliable, forming mold 10 is used to form and shape the sheets around the slide, barrel and trigger guard of weapon 2. It should be noted that forming mold 10 may be used in press 40, which assists in providing the compression force that forms sheets 4 and 5 around the weapon; however, the forming mold may be used without the press by simply pressing and holding upper section 20 and lower section 30 together manually or with other mechanical devices. As shown in FIGS. 9-12, heated sheet 4 is laid over lower section 30, weapon 2 is placed atop the heated sheet 4. Heated sheet 5 is placed over the weapon and heated sheet 4, and upper section 20 is pressed down over lower section 30 compressing the heated sheets around the weapon inside forming mold 10. Weapon 2 sandwiched between the heated sheets is pressed into pads 24 and 26 around weapon 2, which forms and shapes holster front 102 and holster back 104. It should be further noted that weapon 2 is positioned between sheets 4 and 5 within forming mold 10 so that the sheets form around the slide, barrel and trigger guards leaving the grip and rear portion of the slide or hammer exposed. In addition, when positioned within forming mold 10, the sides of sheets 4 and 5 extend over and pass foam pad 34, so that when formed side areas of both sheets have a smooth curvature generally mirroring the curvature of concave surface 23 and convex surface 33. Upper section 20 and lower section 30 are pressed together until holster front 102 and holster back 104 cool and set their shape around weapon 2, which may take several minutes. Once cooled, weapon 2 and the newly formed holster front and back 102 and 104 are removed from forming mold 10. As shown in FIG. 13, both sheets are then cut into the final shape of the holster. The size, shape and configuration of the holster will vary with the size, shape and type of weapon, as well as, the particular style of holster desired. A stencil or outline (not shown) may be used to provided the desired configuration of the holster front and back. Next, holster front and back 102 and 104 are joined together using rivets 106 or alternatively adhesives, stitching or other fasteners as shown in FIG. 15. The holster can be completed by providing the desired attachment means. Separate belt loops (not shown) can be affixed to the holster back or slots 105 can be cut in the side of the joined holster body for belt loops (FIG. 15).

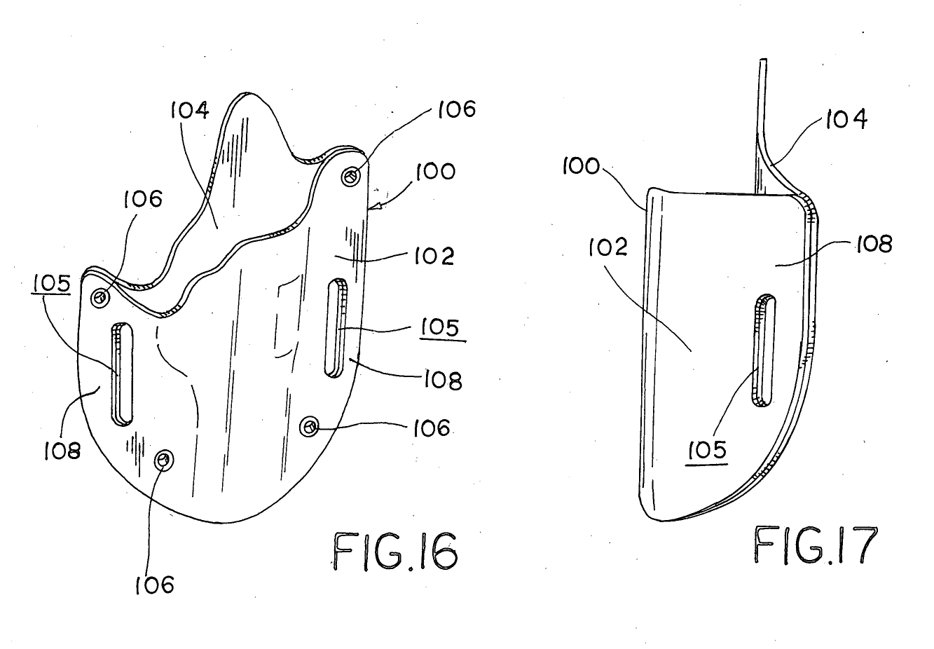

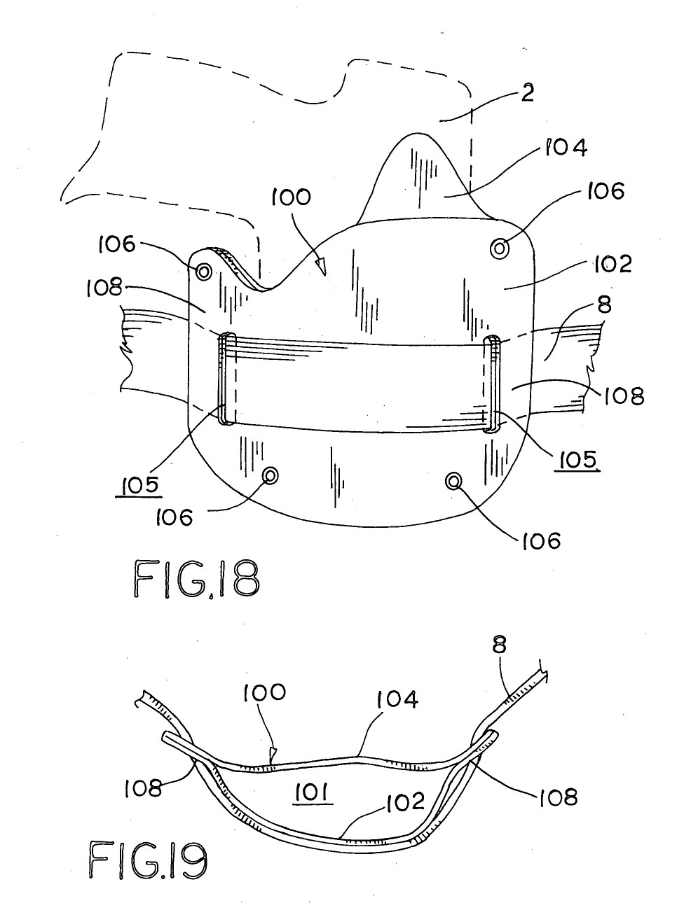

FIGS. 16-19 illustrate a typical embodiment of a holster 100 formed and constructed using the forming mold and method of this invention. When formed using forming mold 10, holster front and back 104 form asymmetrically around weapon 2. As shown in FIGS. 13 and 19, the thickness difference in foam pads 24 and 34 and the curvature of the mating surfaces 23 and 33 allow holster front 102 to form around weapon 2 more than holster back 104. As a result, the impression formed in holster front 102 is more pronounced than the impression in holster back 104, but the weapon cavity 101 formed therebetween still mates perfectly with the weapon and provides sufficient weapon retention. Holster back 104 also has a smoother contour that approximates the curvature of the human hip, which provides a more secure, concealable and comfortable fit for the wearer. As shown, holster 100 is configured to have a wide profile with laterally extending side area 108 through which belt loops 105 extend. When formed, the sides of the sheets 4 and 5 extend laterally past the edge of foam pad 34, so that extended side area 108 of holster 100 have the same smooth continuous curvature as that of concave surface 23 and convex surface 33. Consequently, the sides of holster 100 conform around the wearer's hips and the holster back 104 lays against the wearer without any significant gaps or creases. The wide profile and extended curved sides aid in the concealment of holster 100. Belt loop slots 105 allow a belt to be run around holster front 102 (FIG. 18) which offers better weapon retention and concealment by holding the holster tighter against the body.

The embodiments of the forming mold and the method present invention herein described and illustrated are not intended to be exhaustive or to limit the invention to the precise form disclosed. It is presented to explain the invention so that others skilled in the art might utilize its teachings. The embodiment of the present invention may be modified within the scope of the following claims.

I claim:

1. A mold for thermally forming thermoplastic sheets around an article in the construction of a carrier, such as a holster, comprising:
a first mold section having a concave surface;
a second mold section nestable within the first mold section and having a convex surface;
a first deformable pad mounted to the concave surface of the first mold section; and
a second deformable pad mounted to the convex surface of the second mold section.

2. The mold of claim 1 wherein each of the convex surface of the second mold section and the concave surface of the first mold section has a curvature, the curvature of the convex surface of the second mold section and the curvature of the concave surface of the first mold section are complementary so that the concave surface overlies the convex surface when the first mold section is nested over the second mold section.

3. The mold of claim 1 wherein the curvature of the convex surface of the second mold section and the curvature of the concave surface of the first mold section approximates the curvature of the side of a human hip.

4. The mold of claim 1 wherein the first pad is thicker than the second pad.

5. The mold of claim 1 wherein the convex surface has a recessed formed therein, the second pad is seated within the recess.

6. A method of thermally forming thermoplastic sheets around a weapon in the construction of a holster, the method comprising:
providing a mold, the mold including a first mold section having a concave surface, a second mold section having a convex surface, a first deformable pad mounted to the concave surface, and a second deformable pad mounted to the convex surface;
heating a first thermoplastic sheet and a second thermoplastic sheet so that each of the first sheet and the second sheet are formable;
placing the first heated sheet atop the convex surface of the second mold section so that the first sheet extends over the second pad;
placing the weapon atop the first sheet;
placing the second heated sheet over the weapon and the first sheet; and
compressing the first mold section against the second mold section so that the concave surface of the first mold section overlies the convex surface of the second mold section to press the first heated sheet into the second pad around the weapon and the second heated sheet into the first pad around the weapon, whereby the first heated sheet and the second heated sheet are formed and shaped around the weapon.

7. The method of claim 6 wherein placing the first sheet atop the convex surface of the second mold section so that the first sheet has side areas that extend laterally beyond the second deformable pad.

8. The method of claim 6 also includes allowing the first heated sheet and the second heated sheet to cool while compressed around the weapon between the first mold section and the second mold section.

9. A holster for a weapon comprising:
a holster body having a holster back being constructed from a first thermoplastic sheet and a holster front being constructed from a second thermoplastic sheet, the holster body having a weapon cavity formed between the holster front and the holster back for restrictively receiving the weapon therein, the weapon cavity defined by an impression formed in the holster back in the shape of the weapon and an impression formed in the holster front in the shape of the weapon when the first sheet and the second sheet are heated to a deformable temperature then compressed around the weapon between a first mold section and a second mold section where the first mold section has a concave surface and a first deformable pad mounted to the concave surface and the second mold section has a convex surface and a second deformable pad mounted to the convex surface, so that the impression in the holster front is more pronounced than the impression in the holster back.

10. The holster of claim 9 wherein the first deformable pad is thicker than the second deformable pad.

11. The holster of claim 9 wherein the holster body also has two opposed lateral side areas, the side areas have a curvature formed by compressing the first sheet and the second sheet between the concave surface of the first mold section and the convex surface of the second mold section.
